(19) United States
(12) Patent Application Publication
(10) Pub. No.: US 2023/0163971 A1
(43) Pub. Date: May 25, 2023

(54) PRESENCE PROOF SYSTEM, PRESENCE PROOF METHOD, AND NON-TRANSITORY COMPUTER READABLE MEDIUM

(71) Applicant: NEC Corporation, Minato-ku, Tokyo (JP)

(72) Inventor: Asami TOKUNAGA, Tokyo (JP)

(73) Assignee: NEC Corporation, Minato-ku, Tokyo (JP)

(21) Appl. No.: 17/921,406

(22) PCT Filed: May 21, 2021
(86) PCT No.: PCT/JP2021/019356

§ 371 Date: Oct. 26, 2022

(30) Foreign Application Priority Data
May 22, 2020 (JP) 2020-089428

(51) Int. Cl. H04L 9/32; H04W 12/63

(52) U.S. Cl. CPC H04L 9/3218; H04W 12/63; H04L 9/3231

(57) ABSTRACT

A presence proof system includes a user terminal including a biometric authentication unit, a presence proof request information generation unit, and a data storage unit, a base station including a start time information generation unit, a verification unit, and a presence proof generation unit. The base station transmits, to the user terminal, a start time of presence proof processing, the user terminal transmits, to the base station, an authentication time when the biometric authentication is performed, when the start time, the authentication time, and a verification time in the verification unit are arranged in time series and a difference between the start time and the verification time is within a predetermined range, the base station transmits the presence proof to the user terminal, and the user terminal stores data related to the presence proof received from the base station in a data storage unit.

### TECHNICAL FIELD

The present disclosure relates to a presence proof system, a presence proof method, and a program.

### BACKGROUND ART

There is a known technique that uses a GPS (Global Positioning System) service to specify locations of terminals in detail. However, it is difficult to prove objectively that a certain person is or was at a certain place at a certain time by the service alone. That is, in order to prove objectively the above, indirect information based on ,for example, a third party's sighting of the person or the presence of the person in surveillance camera images, must be presented, as is done in investigations of incidents.

In order to address this problem, Patent Literature 1 discloses a technique to prove a user's location by performing, after fingerprint authentication of the user, positioning and issuing an electronic signature by a server for location information and a time indicated in a result of the positioning.

Patent Literature 2 also discloses a location proof system that proves a user's location in cooperation with an external storage device.

### CITATION LIST

### Patent Literature

Patent Literature 1: Japanese Unexamined Patent Application Publication No. 2003-284113
Patent Literature 2: Japanese Patent No. 4776170

### SUMMARY OF INVENTION

### Technical Problem

There is a problem in the technique disclosed in Patent Literature 1 that if a time lag occurs between performing biometric authentication and positioning, an accurate location proof cannot be obtained if the user moves during this time. The present disclosure has been made in order to solve such a problem, and an object thereof is to provide a presence proof system, a presence proof method, and a program that can appropriately prove a user's location.

### Solution to Problem

In an example aspect of the present disclosure, a presence proof system includes: a user terminal including: a biometric authentication unit for performing biometric authentication of a user; a presence proof request information generation unit for generating presence proof request information for requesting a presence proof, the presence proof proving that a user terminal is present within a communication range of a predetermined base station; and a data storage unit for storing data related to the presence proof; and a base station including: a start time information generation unit for generating start time information including a start time of presence proof processing; a verification unit for verifying validity of the presence proof processing; and a presence proof generation unit for generating the presence proof based on the presence proof processing. The base station transmits, to the user terminal, the start time information generated by the start time information generation unit and including the start time of the presence proof processing, the user terminal transmits, to the base station, the presence proof request information generated by the presence proof request information generation unit and including an authentication time when the biometric authentication unit has performed the biometric authentication of the user, when the start time, the authentication time, and a verification time in the verification unit are arranged in time series and a difference between the start time and the verification time is within a predetermined range, the base station determines that the presence proof processing is valid in the verification unit, generates the presence proof in the presence proof generation unit, and transmits the generated presence proof to the user terminal, and the user terminal stores data related to the presence proof received from the base station in data storage unit.

In another example aspect of the present disclosure, a presence proof method includes: in a base station, generating start time information including a start time of presence proof processing, and transmitting the generated start time information to a user terminal; in the user terminal, generating presence proof request information including an authentication time when a user has been subjected to biometric authentication, and transmitting the generated presence proof request information to the base station; in the base station, when the start time, the authentication time, and a verification time for verifying validity of the presence proof processing are arranged in time series and a difference between the start time and the verification time is within a predetermined range, determining that the presence proof processing is valid, generating the presence proof, and transmitting the generated presence proof to the user terminal; and in the user terminal, storing data related to the presence proof received from the base station.

In another example aspect of the present disclosure, a program for causing a computer to execute processing of: in a base station, generating start time information including a start time of presence proof processing, and transmitting the generated start time information to a user terminal; in the user terminal, generating presence proof request information including an authentication time when a user has been subjected to biometric authentication, and transmitting the generated presence proof request information to the base station; in the base station, when the start time, the authentication time, and a verification time for verifying validity of the presence proof processing are arranged in time series and a difference between the start time and the verification time is within a predetermined range, determining that the presence proof processing is valid, generating the presence proof, and transmitting the generated presence proof to the user terminal; and in the user terminal, storing data related to the presence proof received from the base station.

### Advantageous Effects of Invention

According to the present disclosure, it is possible to provide a presence proof system, a presence proof method, and a program that can appropriately prove a user's location.

### BRIEF DESCRIPTION OF DRAWINGS

FIG. 1 is a block diagram showing a configuration of a presence proof system according to a first example embodiment;

FIG. 2 is a schematic diagram showing a configuration of a presence proof system according to a second example embodiment;

FIG. 3 is a sequence diagram showing presence proof processing;

FIG. 4 is a sequence diagram showing processing for verifying a presence proof;

FIG. 5 is a table showing contents of data transmitted and received between a user terminal and a base station;

FIG. 6 shows an example of a transmission direction of transmission wave beams transmitted by the base station;

FIG. 7 shows an example of a transmission direction of transmission wave beams transmitted by the base station; and

FIG. 8 shows an example of a transmission direction of transmission wave beams transmitted by the base station.

### EXAMPLE EMBODIMENT

### First Example Embodiment

Example embodiments of the present disclosure will be described below with reference to the drawings.

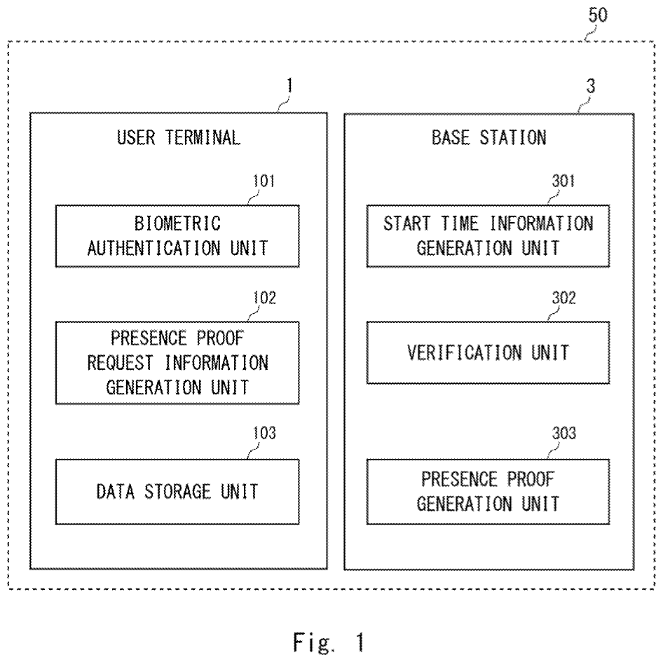

FIG. 1 is a block diagram showing a configuration of a presence proof system 50 according to this example embodiment. The presence proof system 50 includes a user terminal 1 and a base station 3.

The user terminal 1 includes a biometric authentication unit 101, a presence proof request information generation unit 102, and a data storage unit 103.

The biometric authentication unit 101 performs biometric authentication of a user. For example, the biometric authentication unit 101 performs the biometric authentication of the user by using a biometric technique, which is an authentication technique using the user's fingerprint, iris, vein, voiceprint, face shape, etc.

The presence proof request information generation unit 102 generates presence proof request information for requesting a presence proof that proves that the user terminal 1 is present within a communication range of the predetermined base station 3.

The data storage unit 103 stores data related to the presence proof.

The base station 3 includes a start time information generation unit 301, a verification unit 302, and a presence proof generation unit 303.

The start time information generation unit 301 generates start time information including a start time Ta of presence proof processing.

The verification unit 302 verifies validity of the presence proof processing.

The presence proof generation unit 303 generates a presence proof based on the presence proof processing.

The base station 3 transmits, to the user terminal 1, the start time information including the start time Ta of the presence proof processing, which is generated by the start time information generation unit 301.

The user terminal 1 transmits, to the base station 3, the presence proof request information including an authentication time Tb at which the user has been subjected to biometric authentication in the biometric authentication unit 101, which is generated by the presence proof request information generation unit 102.

If the start time Ta, the authentication time Tb, and a verification time Tc in the verification unit 302 are arranged in time series, and a difference between the start time Ta and the verification time Tc is within a predetermined range, the base station 3 determines that the presence proof processing in the verification unit 302 is valid.

The base station 3 generates a presence proof in the presence proof generation unit 303 and transmits the generated presence proof to the user terminal 1.

The user terminal 1 stores, in the data storage unit 103, data related to the presence proof received from the base station 3.

Thus, in the presence proof system 50 according to this example embodiment, the base station 3 generates the start time information including the start time Ta of the presence proof processing. In addition, the user terminal 1 generates the presence proof request information including the authentication time Tb at which the user has been subjected to biometric authentication in the biometric authentication unit 101. The base station 3 determines that if the start time Ta, the authentication time Tb, and the verification time Tc in the verification unit 302 are arranged in time series, and the difference between the start time Ta and the verification time Tc is within the predetermined range, the presence proof processing is valid. That is, in the presence proof system 50 according to this example embodiment, since time series information about the start time Ta, the authentication time Tb, and the verification time Tc is used to determine whether the presence proof processing is valid, it can be properly proved that the user has been within the communication range of the base station 3 at a predetermined timing. Therefore, according to the disclosure of this example embodiment, it is possible to provide a presence proof system, a presence proof method, and a program that can properly prove a user's location.

### Second Example Embodiment

Next, a second example embodiment of the present disclosure will be described. In the second example embodiment, the presence proof system 50 described in the first example embodiment will be described in more detail.

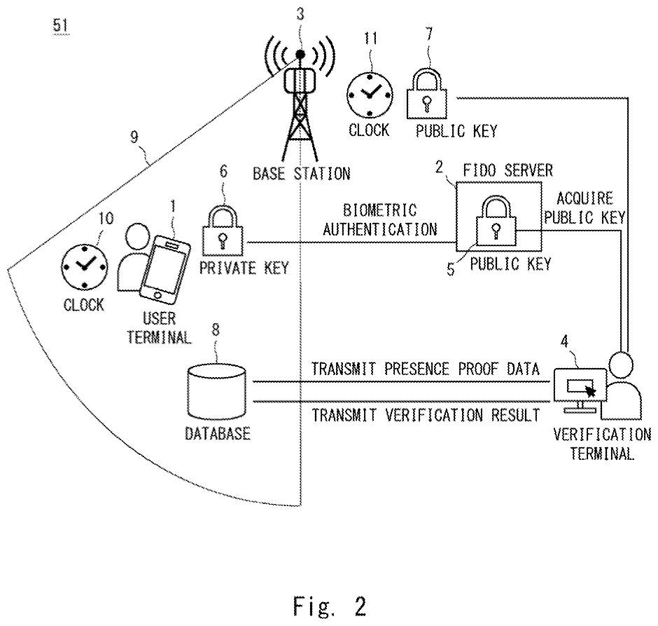

Hereinafter, a presence proof system 51 according to this example embodiment will be described with reference to FIG. 2. FIG. 2 is a schematic diagram showing a configuration of the presence proof system 51 according to this example embodiment. The presence proof system 51 includes a user terminal 1, a FIDO (Fast IDentity Online) server (authentication server) 2, a base station 3, and a verification terminal 4.

The user terminal 1 includes a private key 6, a clock 10, and a database 8. In FIG. 2, these elements are shown outside the user terminal 1 for illustrative purposes, but it is assumed that all of these elements are included in the user terminal 1. Furthermore, the user terminal 1 corresponds to the user terminal 1 described in FIG. 1 and the first example embodiment, and includes the biometric authentication unit 101, the presence proof request information generation unit 102, and the data storage unit 103.

The user terminal 1 is used by a user who uses a presence proof. The user terminal 1 is, for example, a mobile phone, a smartphone, a tablet, or the like. The user terminal 1 is not limited to a portable terminal and instead may be a stationary terminal, such as a desktop personal computer.

The user terminal 1 uses an FIDO service provided by the FIDO server 2. The user terminal 1 registers a public key 5 associated with biometric information in the FIDO server 2 and holds the private key 6 paired with the public key 5. When the biometric authentication of the user is successful, the user terminal 1 performs challenge-response authentication with the base station 3 based on public key cryptography by using the private key 6.

The private key 6 is information used when the user terminal 1 signs presence time information when the biometric authentication is successful at the user terminal 1. The private key 6 is stored in the user terminal 1.

The clock 10 is a clock included in the user terminal 1. The clock 10 provides the authentication time Tb as the time when the user terminal 1 has been subjected to the biometric authentication.

The database 8 stores presence proof data in the user terminal 1.

The FIDO server 2 is a server device that provides FIDO services. The FIDO server 2 registers and holds the public key 5 associated with the user's biometric information. The public key 5 is information paired with the private key 6 that is associated with the encrypted biometric function.

The base station 3 includes a public key 7 and a clock 11. In FIG. 2, these elements are shown outside the base station 3 for illustrative purposes, but it is assumed that all of these elements are included in the base station 3. The base station 3 corresponds to the base station 3 described in FIG. 1 and the first example embodiment, and includes the start time information generation unit 301, the verification unit 302, and the presence proof generation unit 303.

The base station 3 transmits transmission wave beams 9 for wireless communication with the user terminal 1. The base station 3, for example, proves the time by the clock 11, the location of the user terminal 1 from a transmission direction of the transmission wave beams 9, and signs each piece of information. The base station 3 also generates the presence proof data and transmits the generated presence proof data to the user terminal 1.

The public key 7 is information used when information to be provided to the user terminal 1 is signed.

The clock 11 provides the start time Ta as the time to start the presence proof processing. The clock 11 also provides the verification time Tc as an end time of the presence proof.

The verification terminal 4 is used by a person verifying the presence proof of the user terminal 1. The verification terminal 4 is, for example, a personal computer, a mobile phone, a smartphone, a tablet, or the like.

The verification terminal 4 receives the presence proof data from the user terminal 1 when it verifies the presence proof. The verification terminal 4 also acquires the public key 5 of the FIDO server 2 or the public key 7 of the base station 3 and verifies the received presence proof data.

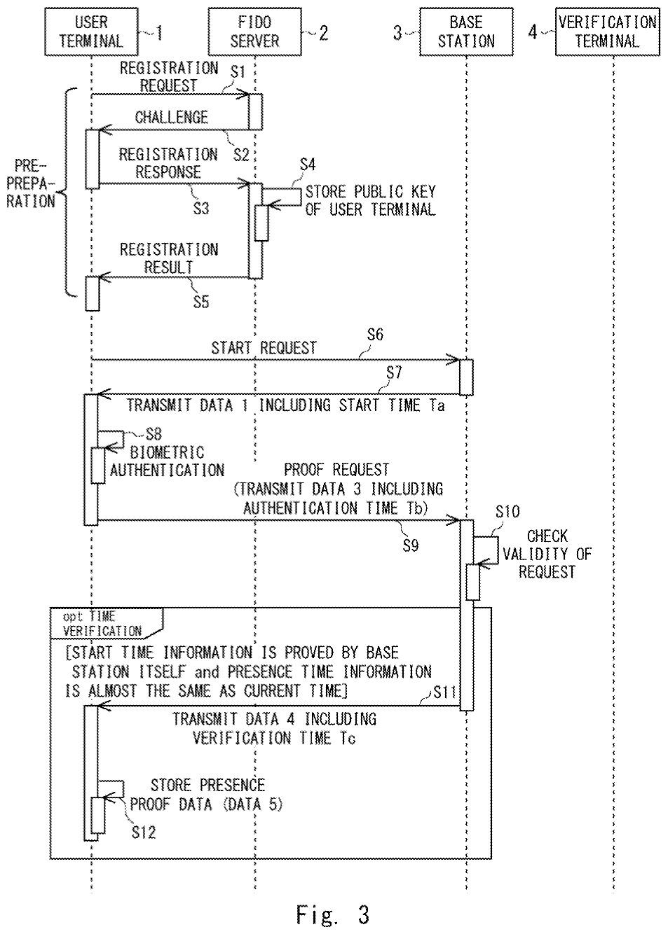

Next, the processing performed by the presence proof system 51 will be described using the sequence diagram shown in FIG. 3. FIG. 3 is a sequence diagram showing the presence proof processing.

First, the user makes pre-preparations to use a biometric service provided by the FIDO server 2 (Steps S1 to S5). The user terminal 1 registers the public key 5 associated with the biometric information in the FIDO server 2. Thus, the user terminal 1 holds the private key 6 and the FIDO server 2 holds its public key 5.

The above processing will be explained in detail. The user terminal 1 requests the FIDO server 2 to register the public key 5 associated with the biometric information about the user terminal 1 (Step S1). The FIDO server 2 transmits challenge data to the user terminal 1 (Step S2). The user terminal 1 sends a registration response to the FIDO server 2 (Step S3). The FIDO server 2 stores the public key 5 of the user terminal 1 (Step S4) and transmits a result of the registration to the user terminal 1 (Step S5). If the registration is successful, the user terminal 1 holds the private key 6 and the pre-preparation is completed. Thus, the user terminal 1 can use the biometric authentication of the FIDO server 2. If registration is not successful, the pre-preparation fails and processing ends.

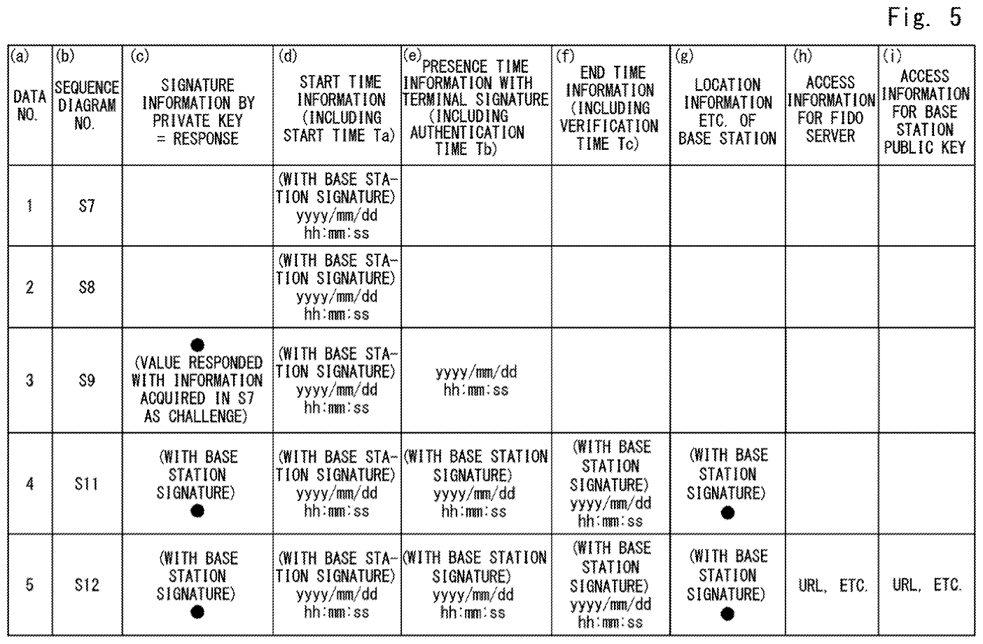

Next, the presence proof processing (Steps S6 to S12) will be described using FIGS. 3 and 5. FIG. 3 is a sequence diagram showing the presence proof processing as described above, and FIG. 5 is a table showing the contents of data transmitted and received between the user terminal 1 and the base station 3 in the presence proof processing. Column (b) of FIG. 5 indicates the number of each step shown in the sequence diagram of FIG. 3. In addition, column (a) of FIG. 5 shows the data number for identifying the data transmitted and received in the processing of the column (b). Columns (c) through (i) of FIG. 5 show an example of the data transmitted and received in each step. Hereinafter, the processing is explained by associating the sequence diagram shown in FIG. 3 with the example of data shown in FIG. 5.

First, the user uses the user terminal 1 to request the base station 3 to start the presence proof processing (Step S6).

The base station 3 (the start time information generation unit 301 shown in FIG. 1) generates the start time information (d) and transmits it to the user terminal 1 (Step S7, data 1). The start time information (d) is information obtained by adding an electronic signature to a fixed identifier representing a start of the presence proof processing and the start time Ta.

The fixed identifier is, for example, a combination of numbers or symbols that uniquely specifies data. Note that the intention of including the fixed identifier of the start of the presence proof processing is to not prevent the base station 3 from signing time information in any processing other than the processing according to the present disclosure.

The start time Ta is the time at the start of the presence proof processing. The start time Ta is provided by the clock 11 of the base station 3. The start time Ta is information corresponding to “year/month/day hours:minutes:seconds” at the start of the presence proof processing, as represented by, for example, “yyyy/mm/dd hh:mm:ss” in the column (d) of FIG. 5. Similarly, the authentication time Tb and the verification time Tc, which will be described later, are acquired in seconds.

Next, the user is subjected to the biometric authentication of the user terminal 1 (the biometric authentication unit 101 shown in FIG. 1) (Step S8).

When the biometric authentication is successful, the user terminal 1 issues a presence proof request to the base station 3 (Step S9). Specifically, the user terminal 1 (the presence proof request information generation unit 102 shown in FIG. 1) generates presence proof request information (data 3) for requesting a presence proof, and transmits the generated information to the base station 3. The presence proof request information is data including the following items:
Response data (c) obtained by calculating the signed start time information (d) of the base station 3 received in Step S7 as a random number for the challenge data
Signed start time information (d) of the base station 3 received in Step S7
Presence time information (e) including the signed authentication time Tb of the user terminal 1

In regard to the above items, the authentication time Tb included in the presence time information (e) is the time when the user terminal 1 has been subjected to the biometric authentication. The authentication time Tb is provided from the clock 10 of the user terminal 1. Signing is performed using the private key 6 stored in the user terminal 1.

When the response data (c) is generated, if the signed start time information (d) of the base station 3 received in Step S7 is too long as the challenge data, a hash value is obtained by a hash function, and the hash value may be used as the challenge data.

The base station 3 (the verification unit 302 shown in FIG. 1) verifies the validity of the request received from the user terminal 1 (Step S10). Specifically, the base station 3 confirms that the start time information (d) transmitted from the user terminal 1 is data signed by the base station 3 itself and includes a fixed identifier representing the start of the presence proof processing. In addition, the base station 3 compares the following three pieces of time information and confirms that the times included in them are in the following order and that the difference between them is within a certain range.
Start time information (d) transmitted from the user terminal 1 . . . Start time Ta
Presence time information transmitted from the user terminal 1 (e) . . . Authentication time Tb
Time information held by the base station 3 . . . Verification time Tc

Here, the verification time Tc is the time when the base station 3 verifies the validity. The verification time Tc is provided by the clock 11 of the base station 3.

As shown above, the start time Ta and the authentication time Tb are included in the start time information (d) and the presence time information (e) transmitted from the user terminal 1, respectively. Therefore, the base station 3 confirms that the start time Ta, the authentication time Tb, and the verification time Tc have been acquired in this order, and that the difference between them is within a certain range. For example, the base station 3 sets in advance a threshold value for the difference between the start time Ta and the verification time Tc. The base station 3 confirms that the start time Ta, the authentication time Tb, and the verification time Tc are acquired in this order, and further confirms that the difference between the start time Ta and the verification time Tc is a value that does not exceed the threshold value. By setting the threshold value sufficiently small, even if the user terminal 1 moves, the presence proof can be properly obtained.

If any of the above conditions is not satisfied, the base station 3 determines that the presence proof request from the user terminal 1 is not valid. In this case, the base station 3 transmits an error message to the user terminal 1, and the presence proof processing ends.

When the user terminal 1 determines that the presence proof request is valid, the base station 3 (the presence proof generation unit 303 shown in FIG. 1) generates the presence proof data (data 4). Specifically, the base station 3 generates the following five pieces of data and digitally signed data by putting these data together.
Fixed identifier representing the end of presence proof processing
Response data (c) transmitted in Step S9
Presence time information (e) with electronic signature transmitted from the user terminal 1
Verification time Tc (f) in Step S10 as the end time information
Location information about the base station 3 and transmission direction (g) of the transmission wave beams 9

The base station 3 transmits the generated presence proof data to the user terminal 1 (Step S11). The user terminal 1 receives the above presence proof data from the base station 3.

The user terminal 1 (the data storage unit 103 shown in FIG. 1) stores the following data pieces (data 5) collectively in the database 8 (Step S12).
Signed start time information (d) received in Step S7
The following data received in Step S11 and its electronic signature
Response data (c)
Presence time information (e) with electronic signature transmitted from the user terminal 1
Verification time Tc (f) in Step S10 as the end time information
Location information (g) about the base station 3 and transmission direction of the transmission wave beams 9
Access information (URL, etc.) (h) for the FIDO server 2
Access information (URL, etc.) (i) for the public key 7 of the base station 3

On the other hand, if the user terminal 1 could not receive the above presence proof data, the presence proof fails and the processing ends.

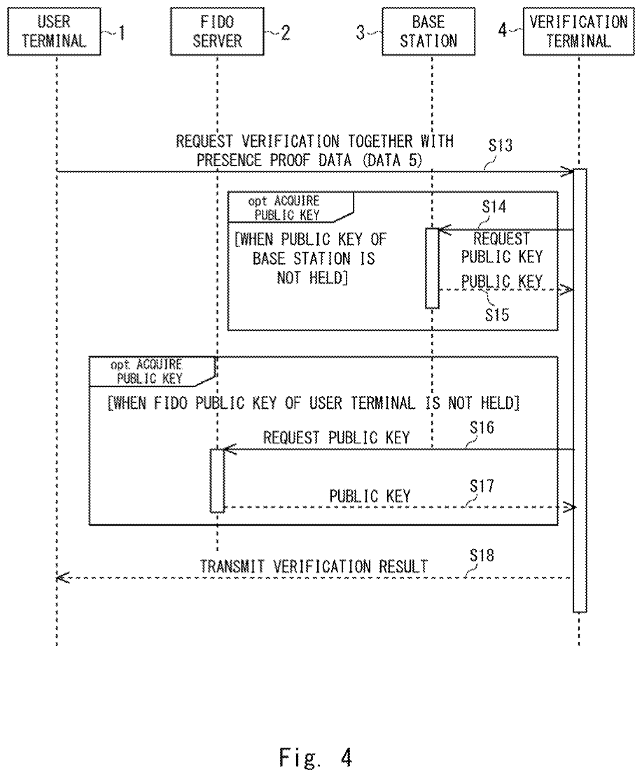

Next, the processing (Steps S13 to S18) for verifying the presence proof will be described using FIG. 4. FIG. 4 is a sequence diagram showing the processing for verifying the presence proof.

The user terminal 1 transmits the presence proof data (data 5) stored in Step S12 to the verification terminal 4 to request verification of the presence proof (Step S13).

The verification terminal 4 requests the public key 7 from the base station 3 as needed (Step S14) and acquires the public key 7 (Step S15). Although FIG. 4 shows, as an example, how the verification terminal 4 acquires the public key 7 by accessing the base station 3, the public key may be acquired by accessing a database installed separately from the base station 3.

Further, the verification terminal 4 requests the public key 5 from the FIDO server 2 as needed (Step S16) and acquires the public key 5 (Step S17). If the verification terminal 4 fails to acquire the public key 5 or 7, verification of the presence proof fails and processing ends.

The verification terminal 4 uses the public keys 5 and 7 to confirm that the presence proof data (data 5) transmitted from the user terminal 1 is signed by the user terminal 1 and the base station 3.

The verification terminal 4 also confirms that the response data (c) is a value generated based on the start time information (d). The verification terminal 4 also confirms that the value of the response data (c) is calculated on or after the start time Ta and on or before the verification time Tc, because the response data (c) is signed by the base station 3 together with the end time information (f).

Furthermore, the verification terminal 4 confirms the location of the user terminal 1 at that time from the location information about the base station 3 and the transmission direction (g) of the transmission wave beams 9.

The verification terminal 4 transmits a result of the verification to the user terminal 1 (Step S18), and the processing for verifying the presence proof is completed. On the other hand, if the user terminal 1 fails to receive the result of the verification, the verification of the presence proof fails and the processing ends.

In the present disclosure, the base station 3 needs to guarantee the following two points.

First, in the processing of Step S7, the base station 3 electronically signs the data obtained by combining the fixed identifier representing the start of the presence proof processing with the start time Ta (data 1), using only the current time as the start time Ta.

Next, in the processing of Step S11, the base station 3 transmits the presence proof data (data 4) including the verification time Tc to the user terminal 1, using only the current time as the verification time Tc.

If these conditions are satisfied, the data 1 transmitted in Step S7 cannot exist before the start time Ta. Furthermore, since the user terminal 1 generates the response data (c) for the data 1 by using the private key 6, it can be proved that the time when the user terminal 1 has been subjected to the biometric authentication is later than the start time Ta. Then, in Step S11, the base station 3 includes the above response data (c) and end time information (f) in the transmission data (data 4) to be transmitted to the user terminal 1. Since the end time information (f) includes the verification time Tc as the end time of the presence proof, it can be proved that the biometric authentication performed at the user terminal 1 has been completed before the verification time Tc.

As described above, by making the difference between the start time Ta and the verification time Tc sufficiently short, it can be proved that a person matching the biometric information is present at the time (strictly, some moment in a short period of time) and location indicated by the base station 3.

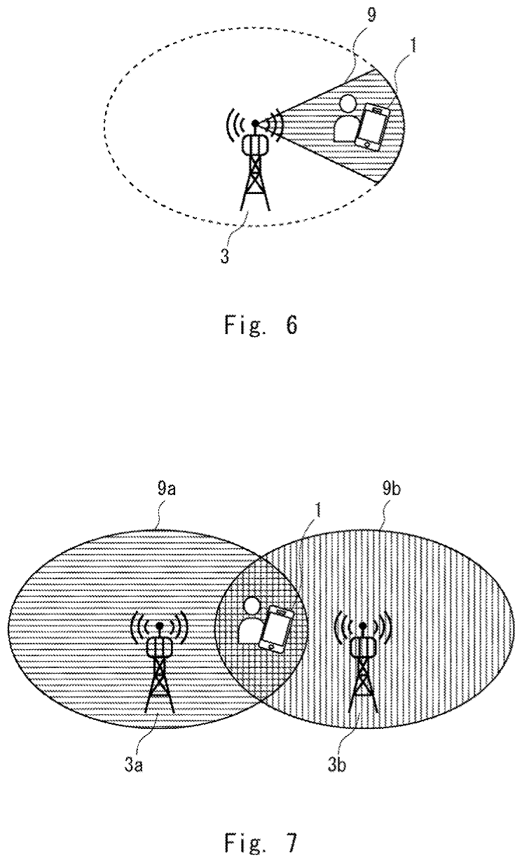

Next, a supplementary description about the transmission direction of the transmission wave beams 9 will be given with reference to FIGS. 6 to 8. FIGS. 6 to 8 show an example of the transmission direction of the transmission wave beams 9 transmitted by the base station 3.

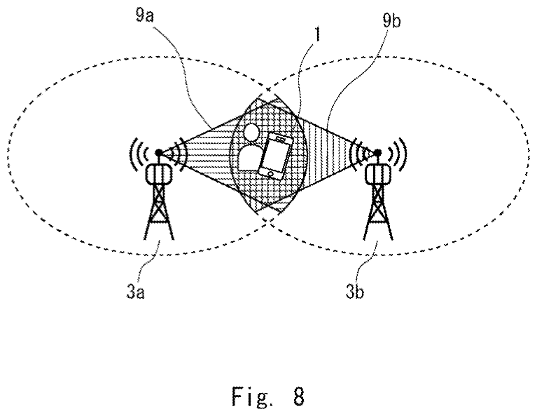

Normally, the transmission wave beams 9 are transmitted concentrically around the base station 3, but as shown in FIG. 6, the transmission wave beams 9 may be transmitted in a fan shape only in a certain direction within the concentric circle. In addition, as shown in FIGS. 7 and 8, the user terminal 1 may simultaneously request presence proof for a plurality of base stations 3a and 3b. For example, in the example shown in FIG. 7, transmission wave beams 9a and 9b of the base stations 3a and 3b are transmitted concentrically around the respective base stations 3a and 3b, and the user terminal 1 is present in the area where they overlap. This enables the location of the user terminal 1 to be specified more accurately, and thus the high-precision presence proof can be obtained. In this case, the base stations 3a and 3b may transmit fan-shaped transmission wave beams 9a and 9b as shown in FIG. 8.

As described above, the presence proof system of example embodiment provides more accurate proof of the time and location of the user's presence by having the signatures issued at the start and end of the presence proof processing and the time information of start and end of the presence proof processing in addition to the information of the biometric authentication by the FIDO server. This enables an appropriate proof of the user's location to be obtained.

Patent Literature 2 also discloses a location proof system that proves a user's location in cooperation with an external storage device, in which information to be proved is stored in the external storage device. Thus, there is a problem that an amount of data for presence proof is limited by the external device. There is also a bottleneck in data access, because proof data is present on a specific device.

On the other hand, in the presence proof system according to this example embodiment, since the presence proof data is stored in the user terminal 1 (the data storage unit 103 shown in FIG. 1), the constraint on the amount of resources of the external device can be avoided. Therefore, even when there are a large number of user terminals, the bottleneck in the data access can be eliminated, because the presence proof data is stored in each terminal in a distributed manner.

According to a presence proof method of this example embodiment, in a base station, generating start time information including a start time Ta of presence proof processing, and transmitting the generated start time information to a user terminal, in the user terminal, generating presence proof request information including an authentication time Tb when a user has been subjected to biometric authentication, and transmitting the generated presence proof request information to the base station, in the base station, when the start time Ta, the authentication time Tb, and a verification time Tc for verifying validity of the presence proof processing are arranged in time series and a difference between the start time Ta and the verification time Tc is within a predetermined range, determining that the presence proof processing is valid, generating the presence proof, and transmitting the generated presence proof to the user terminal, and in the user terminal, storing data related to the presence proof received from the base station. Thus, it is possible to appropriately prove a user's location.

In addition, the presence proof processing according to this example embodiment may be performed by executing a program in each of the user terminal 1, the base station 3, and the verification terminal 4. These programs are stored in the memory provided in the user terminal 1, the base station 3, and the verification terminal 4. In addition, the user terminal 1, the base station 3, and the verification terminal 4 can read the programs from their respective memories and execute the respective programs on their respective processors, thereby performing the above mentioned presence proof processing.

In addition, software of the existing base station may be modified to make the base station 3 perform the above processing. When the software of the existing base station is modified in this way, the effect on an existing operation of the base station can be minimized, because each processing for the presence proof can be executed in a stateless manner.

The processor may be, for example, a microprocessor, a Micro Processing Unit (MPU), or a Central Processing Unit (CPU). The processor may include more than one processor.

The memory is composed of a combination of volatile and non-volatile memories. The memory may include a storage located separate from the processor. In this case, the processor may access the memory through an I/O interface not shown.

Each of the processors executes one or more programs including instructions to cause a computer to perform the algorithm described using the drawings. The programs can be stored and provided to the computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), Compact Disc Read Only Memory (CD-ROM), CD-R, CD-R/W, and semiconductor memories (such as mask ROM, PROM (Programmable ROM), EPROM (Erasable PROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above example embodiments and can be modified as appropriate without departing from the scope of the present disclosure.

For example, in the examples described above, the base station 3 having the user terminal 1 within a range of the transmission wave beams 9 is used. However, the present disclosure may be applied to a Wi-Fi (registered trademark) router operated by a business operator. A Wi-Fi router can be used to specify when a user was within a smaller radius.

In the above example, the base station 3 is described by using the location information about the base station 3 and the transmission direction information about the transmission wave beams 9 used in the communication with the user terminal 1 as information related to the location of the user terminal 1, but the present disclosure is not limited to this. For example, more detailed location information about the user terminal 1, such as estimated location information obtained by a function of the base station 3 or three-point survey results obtained by cooperating among adjacent base stations, can be added, and the data including them with an electronic signature can be sent back to the user terminal 1.

Examples of application of the present disclosure include the following.

In the future, if location information about emergency vehicles is to be distributed over the network, this information can only be distributed to vehicles that have been proven to be in the vicinity of the emergency vehicles. This prevents a user from faking location information about his or her own vehicle to fraudulently track information about emergency vehicles. Using the present disclosure, a proof of the user's presence at a location can be obtained at any time and frequency.

By applying the present disclosure to a stamp rally system service using a user's mobile terminal, an illegal act of faking location information can be prevented. For example, in a game application for a mobile terminal, if there is an item that can be acquired only by a user who is in a specific region and location information is faked, the item can be acquired illegally without moving to the region. In the present disclosure, such an illegal act can be prevented, because the location information about the base station and the transmission direction of the transmission wave beams are used instead of relying only on the location information about the mobile terminal. In addition, since the time information about the mobile terminal side can be confirmed by the base station, an illegal act of faking the time information can also be prevented.

In a user-participatory local information service, it is possible to prove that the user certainly has information about the place. For example, when a review of a restaurant is posted, it can be proven that the user has visited the restaurant in the past, and the content of the review can be given credibility. Similarly, in a service that aggregates weather information about a user's current location, train congestion status, etc., by posting information, the accuracy of the information can be enhanced by preventing faking of the current location.

In an entertainment system intended for end-user use, the present disclosure can also be used as follows.
Proof of participation in offline events (such as being at the Olympic opening ceremony)
Proof that a user has been to a ruin or famous place (such as an issuance of a privilege or shrine's red ink stamp)
Commemorating a tour of the annular eclipse (because annular eclipse can only be seen at certain times and places)

The present disclosure can be applied as a way to enhance the reliability of existing electronic signature services. For example, information about where an electronic signature has been physically performed is included as a part of electronic signature data. In this way, if a person with no departure record has a record of signing an electronic signature in a foreign country, it can be determined that the electronic signature is fraudulent. It can be also determined that an electronic signature made in an unreasonable location is fraudulent.

The present disclosure can be applied as means for detecting unauthorized use of credit cards. For example, an optional feature that requires the submission of presence proof data as part of the credit card proof processing is added. Card users can select the presence proof option. If the card user selects the presence proof option, he/she is required to present the presence proof data as one of authentication data when using a credit card, in addition to a password. The credit card company compares information about a credit card dealer with information about a place indicated by the presence proof data and fails authentication if the place is not appropriate.

When a user accesses a computer, the disclosure can be applied as a way to increase the reliability that the access is valid. Security can be improved by requiring a presence proof to acquire certain privileges when a user accesses a computer.

The above description is an example, and the present disclosure can be applied to various kinds of proof, such as an alibi evidence in investigations of incidents and proof of business trips at companies.

The present disclosure has been described above with reference to the example embodiment, but the present disclosure is not limited by the above. Various modifications that can be understood by those skilled in the art within the scope of the disclosure can be made to the configuration and details of the present disclosure.

This application claims priority on the basis of Japanese Patent Application No. 2020-089428, filed May 22, 2020, the entire disclosure of which is incorporated herein by reference.

### REFERENCE SIGNS LIST

1 USER TERMINAL
2 FIDO SERVER
3 BASE STATION
4 VERIFICATION TERMINAL
5, 7 PUBLIC KEY
6 PRIVATE KEY
8 DATABASE
9 TRANSMISSION WAVE BEAM
10, 11 CLOCK
50, 51 PRESENCE PROOF SYSTEM
101 BIOMETRIC AUTHENTICATION UNIT
102 PRESENCE PROOF REQUEST INFORMATION GENERATION UNIT
103 DATA STORAGE UNIT
301 START TIME INFORMATION GENERATION UNIT
302 VERIFICATION UNIT
303 PRESENCE PROOF GENERATION UNIT

What is claimed is:

1. A presence proof system comprising:
a user terminal comprising:
at least one memory storing instructions, and
at least one processor configured to execute the instructions to:
perform biometric authentication of a user;
generate presence proof request information for requesting a presence proof, the presence proof proving that a user terminal is present within a communication range of a predetermined base station; and
store data related to the presence proof; and
a base station comprising:
at least one memory storing instructions, and
at least one processor configured to execute the instructions to:
generate start time information including a start time of presence proof processing;
verify validity of the presence proof processing; and
generate the presence proof based on the presence proof processing, wherein
the at least one processor of the base station is configured to execute the instructions to transmit, to the user terminal, the generated start time information including the start time of the presence proof processing,
the at least one processor of the user terminal is configured to execute the instructions to transmit, to the base station, the generated presence proof request information including an authentication time when the biometric authentication of the user has been performed,
when the start time, the authentication time, and a verification time are arranged in time series and a difference between the start time and the verification time is within a predetermined range, the at least one processor of the base station is configured to execute the instructions to determine that the presence proof processing is valid, generate the presence proof, and transmit the generated presence proof to the user terminal, and
the at least one processor of the user terminal is configured to execute the instructions to store data related to the presence proof received from the base station.

2. The presence proof system according to claim 1, further comprising:
an authentication server comprising:
at least one memory storing instructions, and
at least one processor configured to execute the instructions to:
register a public key associated with the biometric information about the user, wherein
the at least one processor of the user terminal is further configured to execute the instructions to electronically sign the presence proof request information using a private key corresponding to the public key and transmit the electronically signed presence proof request information to the base station.

3. The presence proof system according to claim 2, further comprising:
a verification terminal comprising:
at least one memory storing instructions, and
at least one processor configured to execute the instructions to:
receive the presence proof from the user terminal and verify location information about the user terminal, wherein
the at least one processor of the verification terminal is configured to execute the instructions to acquire the public key from the authentication server and verify the location information about the user terminal by using the acquired public key and the presence proof received from the user terminal.

4. The presence proof system according to claim 2, wherein
the start time information further includes a fixed identifier indicating a start of the presence proof processing,
the at least one processor of the base station is further configured to execute the instructions to transmit the electronically signed start time information to the user terminal, and
the at least one processor of the user terminal is further configured to execute the instructions to transmit the authentication time signed with the private key, the electronically signed start time information received from the base station, and the fixed identifier to the base station as the presence proof request information.

5. The presence proof system according to claim 4, wherein
the at least one processor of the user terminal is further configured to execute the instructions to include the electronically signed start time information received from the base station in the presence proof request information and transmit the presence proof request information including the start time information to the base station, and
when the electronically signed start time information is data signed by the base station itself, the at least one processor of the base station is further configured to execute the instructions to determine that the presence proof processing is valid.

6. The presence proof system according to claim 4, wherein
the at least one processor of the user terminal is further configured to execute the instructions to generate response data by using the electronically signed start time information received from the base station as challenge data and transmit the generated response data to the base station.

7. The presence proof system according to claim 1, wherein
the generated presence proof includes at least location information about the base station and information about the authentication time.

8. The presence proof system according to claim 7, wherein
the generated presence proof further includes information about a beam direction of a transmission wave transmitted from the base station.

9. A presence proof method comprising:
in a base station, generating start time information including a start time of presence proof processing, and transmitting the generated start time information to a user terminal;
in the user terminal, generating presence proof request information including an authentication time when a user has been subjected to biometric authentication, and transmitting the generated presence proof request information to the base station;
in the base station, when the start time, the authentication time, and a verification time for verifying validity of the presence proof processing are arranged in time series and a difference between the start time and the verification time is within a predetermined range, determining that the presence proof processing is valid, generating the presence proof, and transmitting the generated presence proof to the user terminal; and
in the user terminal, storing data related to the presence proof received from the base station.

10. A non-transitory computer readable medium storing a program for causing a computer to execute processing of:
in a base station, generating start time information including a start time of presence proof processing, and transmitting the generated start time information to a user terminal;
in the user terminal, generating presence proof request information including an authentication time when a user has been subjected to biometric authentication, and transmitting the generated presence proof request information to the base station;
in the base station, when the start time, the authentication time, and a verification time for verifying validity of the presence proof processing are arranged in time series and a difference between the start time and the verification time is within a predetermined range, determining that the presence proof processing is valid, generating the presence proof, and transmitting the generated presence proof to the user terminal; and
in the user terminal, storing data related to the presence proof received from the base station.
